(19) United States
(12) Patent Application Publication
(10) Pub. No.: US 2023/0196291 A1
(43) Pub. Date: Jun. 22, 2023

(54) METHODS AND SYSTEMS FOR MONITORING PROJECTS AND PROVIDING ALERTS AND RECOMMENDATIONS

(71) Applicant: IVTREE IT Solutions Private Limited, Bangalore (IN)

(72) Inventors: Soham Kar, Kolkata (IN); Martin Joy Tharayil, Kochi (IN)

(21) Appl. No.: 17/553,022

(22) Filed: Dec. 16, 2021

(51) Int. Cl. G06Q 10/10; G06Q 10/06

(52) U.S. Cl. CPC G06Q 10/103; G06Q 10/063114; G06Q 10/063116

(57) ABSTRACT

Historical data pertaining to past project is classified into phases and corresponding sub-phases. A plurality of parameters of a software code associated with a given sub-phase and a total time spent in finishing the given sub-phase is determined. A correlation between the plurality of parameters determined for the given sub-phase and the total time spent in finishing the given sub-phase is then found. A learning model is trained based on said correlation. An ongoing project is divided into ongoing phases and corresponding ongoing sub-phases and next phases and corresponding next sub-phases. The learning model is employed to determine a time that is estimated to be required to finish each ongoing phase and the corresponding ongoing sub-phases. The time that is estimated to be required is then compared with an actual time spent on each ongoing phase and the corresponding ongoing sub-phases, to track a progress of the ongoing project.

### TECHNICAL FIELD

The present disclosure relates to methods for tracking a progress of a project and providing alerts and recommendations. Moreover, the present disclosure also relates to systems for tracking a progress of a project and providing alerts and recommendations.

### BACKGROUND

Organisations throughout the world spend significant effort to efficiently curate scheduling strategies pertaining to estimating, tracking and forecasting the progress of a project. Based on such scheduling strategies, the organisations further plan and allot their resources to various pending projects and tasks related thereto.

Traditionally, such scheduling strategies have been curated by receiving inputs from key stakeholders, for example, task managers, designers, coders and the like, and then aggregating the inputs to make an overall estimation. However, in such a case, reliance on an individual stakeholder's assessment means that the overall estimation will be susceptible to incorrect assumptions and miscalculations, thereby bringing subjectivity to the overall process. The challenge is further compounded as often there is a scenario that different stakeholders are collaborating remotely towards the completion of the project. As multiple individuals are required to work parallelly on multiple portions of the project, it further complicates the process of providing an estimate for the progress of the project.

Underestimation of the time required for completion of the project would lead to time pressures that may compromise the quality of the project. On the other hand, overestimation of the time required for completion may lead to unnecessary delay in product delivery. Therefore, it is desirable that a correct estimation of the time required for completion of the project be made.

### SUMMARY

The present disclosure seeks to provide an improved method for tracking a progress of a project. The present disclosure also seeks to provide an improved system for tracking a progress of a project. Moreover, the present disclosure also seeks to provide a solution to the aforementioned existing problems in the prior art.

In one aspect, an embodiment of the present disclosure provides a computer-implemented method comprising:
receiving, from a data repository, data pertaining to at least one past project;
classifying the data pertaining to the at least one past project into a plurality of phases and their corresponding sub-phases;
for each sub-phase of each phase:
   determining a plurality of parameters of a software code associated with a given sub-phase;
   determining a total time spent in finishing the given sub-phase;
   finding a correlation between the plurality of parameters determined for the given sub-phase and the total time spent in finishing the given sub-phase;
training a learning model, based on said correlation;
dividing an ongoing project into a plurality of ongoing phases and their corresponding ongoing sub-phases and a plurality of next phases and their corresponding next sub-phases;
employing the learning model to determine a time that is estimated to be required to finish each of the plurality of ongoing phases and their corresponding ongoing sub-phases; and
comparing the time that is estimated to be required with an actual time spent on each of the plurality of ongoing phases and their corresponding ongoing sub-phases, to track a progress of the ongoing project.

In another aspect, an embodiment of the present disclosure provides a system comprising:
memory;
one or more processors; and
one or more programs stored in the memory and configured for execution by the one or more processors, the one or more programs including instructions to:
   receive, from a data repository, data pertaining to at least one past project;
   classify the data pertaining to the at least one past project into a plurality of phases and their corresponding sub-phases;
   for each sub-phase of each phase:
      determine a plurality of parameters of a software code associated with a given sub-phase;
      determine a total time spent in finishing the given sub-phase;
      find a correlation between the plurality of parameters determined for the given sub-phase and the total time spent in finishing the given sub-phase;
   train a learning model, based on said correlation;
   divide an ongoing project into a plurality of ongoing phases and their corresponding ongoing sub-phases and a plurality of next phases and their corresponding next sub-phases;
   employ the learning model to determine a time that is estimated to be required to finish each of the plurality of ongoing phases and their corresponding ongoing sub-phases; and
   compare the time that is estimated to be required with an actual time spent on each of the plurality of ongoing phases and their corresponding ongoing sub-phases, to track a progress of the ongoing project.

Embodiments of the present disclosure substantially eliminate or at least partially address the aforementioned problems in the prior art, and enable an accurate and reliable estimation of a time that is required to finish a given phase or sub-phase of a project, and further enables a user to track the progress of the project in light of historical data pertaining to past projects.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of architecture of a system for tracking a progress of a project, in accordance with an embodiment of the present disclosure; and

FIGS. 2A and 2B depict steps of a method for tracking a progress of a project, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a computer-implemented method comprising:
receiving, from a data repository, data pertaining to at least one past project;
classifying the data pertaining to the at least one past project into a plurality of phases and their corresponding sub-phases;
for each sub-phase of each phase:
   determining a plurality of parameters of a software code associated with a given sub-phase;
   determining a total time spent in finishing the given sub-phase;
   finding a correlation between the plurality of parameters determined for the given sub-phase and the total time spent in finishing the given sub-phase;
training a learning model, based on said correlation;
dividing an ongoing project into a plurality of ongoing phases and their corresponding ongoing sub-phases and a plurality of next phases and their corresponding next sub-phases;
employing the learning model to determine a time that is estimated to be required to finish each of the plurality of ongoing phases and their corresponding ongoing sub-phases; and
comparing the time that is estimated to be required with an actual time spent on each of the plurality of ongoing phases and their corresponding ongoing sub-phases, to track a progress of the ongoing project.

In another aspect, an embodiment of the present disclosure provides a system comprising:
memory;
one or more processors; and
one or more programs stored in the memory and configured for execution by the one or more processors, the one or more programs including instructions to:
   receive, from a data repository, data pertaining to at least one past project;
   classify the data pertaining to the at least one past project into a plurality of phases and their corresponding sub-phases;
   for each sub-phase of each phase:
      determine a plurality of parameters of a software code associated with a given sub-phase;
      determine a total time spent in finishing the given sub-phase;
      find a correlation between the plurality of parameters determined for the given sub-phase and the total time spent in finishing the given sub-phase;
   train a learning model, based on said correlation;
   divide an ongoing project into a plurality of ongoing phases and their corresponding ongoing sub-phases and a plurality of next phases and their corresponding next sub-phases;
   employ the learning model to determine a time that is estimated to be required to finish each of the plurality of ongoing phases and their corresponding ongoing sub-phases; and
   compare the time that is estimated to be required with an actual time spent on each of the plurality of ongoing phases and their corresponding ongoing sub-phases, to track a progress of the ongoing project.

The aforementioned method and system enable an accurate and reliable estimation of a time that is required to finish a given phase or sub-phase of a project. The method and system employ machine learning techniques for tracking the progress of the project in light of historical data pertaining to past projects.

Throughout the present disclosure, the term “project” refers to a software development project. Generally, a team of software developers are required to collaborate on a project for developing a software. The software developers are provided access to a development environment on which development and testing of the software can be performed. Such a development environment allows the software developers to write and modify a code of the software. It will be appreciated that the code may be written in any programming language (for example, such as C, C++, JAVA, Python and the like).

Prior to actually starting to develop the code, the team of software developers has to outline an entire software development life cycle. As an example, the software development life cycle can be segmented into the following: analyzing a problem to be solved by the software; performing market research; gathering specification requirements of the software; devising a plan for implementing the code of the software; writing the code; testing and debugging the code; deployment of the software; maintenance and bug fixing. The plan for implementing the code involves dividing the project into a plurality of phases and dividing each phase into its corresponding sub-phases.

During each phase and sub-phase, the software developers write their own individual portions of the code and then collaborate all the portions together, whilst ensuring that different portions of the code can interoperate with each other. A workflow indicating a timeline in which each phase and sub-phase is to be completed is created. Optionally, in this regard, the method further comprises employing the learning model to estimate a time required to finish each phase and sub-phase. Such a workflow helps the software developers in evaluating a progress of their work and communicating with each other throughout the entire process of software development.

Pursuant to embodiments, the method is susceptible to be utilized for an ongoing project. Optionally, in this regard, the method further comprises employing the learning model to estimate a time required to finish one or more of the plurality of next phases and their corresponding next sub-phases. The technical benefit of this is that the further time required to finish the project can be predicted from a given point of time.

As mentioned earlier, the method can be utilized for tracking the progress of the ongoing project. Optionally, the step of tracking the progress of the ongoing project comprises determining whether or not an actual time spent on a given ongoing phase or sub-phase exceeds the time that is estimated to be required to finish the given ongoing phase or sub-phase, wherein the method further comprises sending an alert message to a user when the actual time spent on the given ongoing phase or sub-phase exceeds the time that is estimated to be required to finish the given ongoing phase or sub-phase.

Moreover, optionally, the alert message is generated based on a magnitude of difference between the actual time spent on the given ongoing phase or sub-phase and the estimated time to finish the given ongoing phase or sub-phase, when the actual time exceeds the estimated time. For example, if the magnitude of difference exceeds a predefined threshold, a red alert may be raised and the alert message may be generated accordingly. The predefined threshold may be user-defined or system-defined by default.

Optionally, the alert message comprises a recommendation suggesting a corrective action to be taken. Such a recommendation is particularly beneficial when a red alert has been raised, namely when the magnitude of difference exceeds the predefined threshold. As an example, the recommendation may identify a particular type of error that has re-occurred several times during the project and a corrective action to be taken to avoid that particular type of error. As another example, the recommendation may suggest to employ a particular number of additional software developers in the team, so as to be able to finish the project as per a previously-determined timeline.

Furthermore, as mentioned earlier, the learning model is trained based on the data pertaining to the at least one past project (namely, the historical data pertaining to the at least one past project). It will be appreciated that the at least one past project may be selected from amongst a plurality of past projects based on a type of the project. In other words, the at least one past project should belong to the same technical domain as the project being tracked. Alternatively, the at least one past project may be selected based on a user's input or preference. Yet alternatively, the project being tracked may be an update that is required to be made on the at least one past project. For example, when an existing software application is to be updated to provide a new feature, the project pertains to developing the updated software application.

The historical data is classified into the plurality of phases and their corresponding sub-phases. For each sub-phase of each phase, the plurality of parameters of the software code associated with the given sub-phase are determined. Optionally, in this regard, the plurality of parameters comprise at least one of: lines of code in the given sub-phase, a programming language used, time lapsed between release of a preceding sub-phase and the given sub-phase, cyclomatic complexity of the software code in the given sub-phase, defects resolved during the given sub-phase, a number of commits performed during the given sub-phase, files modified during each commit.

Subsequently, the total time spent in finishing the given sub-phase is determined. Optionally, information about the total time spent in finishing the given sub-phase is obtained from the historical data. In this regard, the historical data can be obtained from a bug tracking tool that was used for the at least one past project. Additionally or alternatively, optionally, the method further comprises:
receiving a user feedback on a status of each sub-phase;
assigning a weight to a cumulation of preceding sub-phases of the given sub-phase, based on the user feedback; and
employing the assigned weight when determining the total time spent in finishing the given sub-phase.

The weight is assigned to the cumulation of preceding sub-phases, because a given sub-phase typically affects all subsequent sub-phases. For example, let us consider that a given phase comprises N sub-phases. In such a case, an N^{th} sub-phase will depend on all sub-phases prior to it, namely from a 1^{st} sub-phase to an N−1^{th} sub-phase. The assigned weight may be employed to determine the total time spent in finishing the given sub-phase as follows:

i=sum(Wx*time spend in fixing is sprint x) where i<x<N.

wherein

‘Wx’ is a weight assigned to the cumulation of preceding sub-phases,

‘x’ represents each sub-phase, and

‘i’ represents the time spent in finishing the given sub-phase.

Thus, ‘i’ is calculated as a sum of products of ‘Wx’ and time spent in fixing a preceding sub-phase ‘x’, where I<x<N.

Upon determining the total time spent in finishing the given sub-phase, a correlation between the plurality of parameters determined for the given sub-phase and the total time spent in finishing the given sub-phase is found. Optionally, the step of finding the correlation comprises finding a correlation between a given parameter and a time spent in fixing at least one bug arising in the software code due to the given parameter.

Optionally, in this regard, the method further comprises calculating a complexity factor associated with the plurality of parameters determined for the given sub-phase. Herein, the term “complexity factor” refers to a factor (for example, a score) that indicates a level of complexity involved during generation of a given portion of code that is associated with the given sub-phase. Mathematically, the complexity factor can be represented as:

Complexity=g(x1,x2, . . . ,xn),

wherein ‘x1, x2, . . . , xn’ represent values of the plurality of parameters that are determined for the given sub-phase, and

‘g’ is a function based on machine learning.

Upon calculating the complexity factor, another function ‘f’ is applied to the complexity factor to map it to the time spent in finishing the given sub-phase. Mathematically, this may be represented as:

Y=f(g(x1,x2, . . . ,xn))

The functions ‘f’ and ‘g’ may be combined into a single function ‘F’, and written as follows:

Y=F(x1,x2, . . . ,xn)

The functions ‘f’ as well as the function ‘F’ are based on machine learning. In other words, the functions ‘f’, ‘g’ and ‘F’ are determined by employing a machine learning technique on the historical data pertaining to the at least one past project. Optionally, the aforesaid functions are determined based on a covariance between the time required to finish a given phase or sub-phase with each of the plurality of parameters.

In this regard, it may be assumed that the plurality of parameters are not closely related, namely they do not have a tight relationship.

In this way, the correlation between the plurality of parameters determined for the given sub-phase with the total time spent in finishing the given sub-phase is found. Finally, the learning model is trained based on said correlation.

Optionally, in this regard, the learning model comprises at least one of: a linear regression model, a classification model, a random forest model, a stochastic gradient boost model, a deep neural network, a prediction model, a support vector machine model, an artificial neural network model, a lasso regression model, a data mining model, a frequent rule mining model, a pattern discovery model.

The learning model may be trained using only a portion of the historical data. Once trained, the learning model can be tested using a remaining portion of the historical data. As an example, 75% of the historical data may be used for training the learning model, whereas remaining 25% of the historical data may be used for testing the trained learning model.

The present disclosure also relates to the method as described above. Various embodiments and variants disclosed above apply mutatis mutandis to the system.

Optionally, the instructions to find the correlation comprises instructions to find a correlation between a given parameter and a time spent in fixing at least one bug arising in the software code due to the given parameter.

Optionally, the plurality of parameters comprise at least one of: lines of code in the given sub-phase, a programming language used, time lapsed between release of a preceding sub-phase and the given sub-phase, cyclomatic complexity of the software code in the given sub-phase, defects resolved during the given sub-phase, a number of commits performed during the given sub-phase, files modified during each commit.

Moreover, optionally, the one or more programs further include instructions to:
receive a user feedback on a status of each sub-phase;
assign a weight to a cumulation of preceding sub-phases of the given sub-phase, based on the user feedback; and
employ the assigned weight when determining the total time spent in finishing the given sub-phase.

Furthermore, optionally, the instructions to track the progress of the ongoing project comprises instructions to determine whether or not an actual time spent on a given ongoing phase or sub-phase exceeds the time that is estimated to be required to finish the given ongoing phase or sub-phase, wherein the one or more programs further include instructions to send an alert message to a user when the actual time spent on the given ongoing phase or sub-phase exceeds the time that is estimated to be required to finish the given ongoing phase or sub-phase. Optionally, the alert message comprises a recommendation suggesting a corrective action to be taken.

Moreover, optionally, the one or more programs further include instructions to employ the learning model to estimate a time required to finish one or more of the plurality of next phases and their corresponding next sub-phases.

### DETAILED DESCRIPTION OF THE DRAWINGS

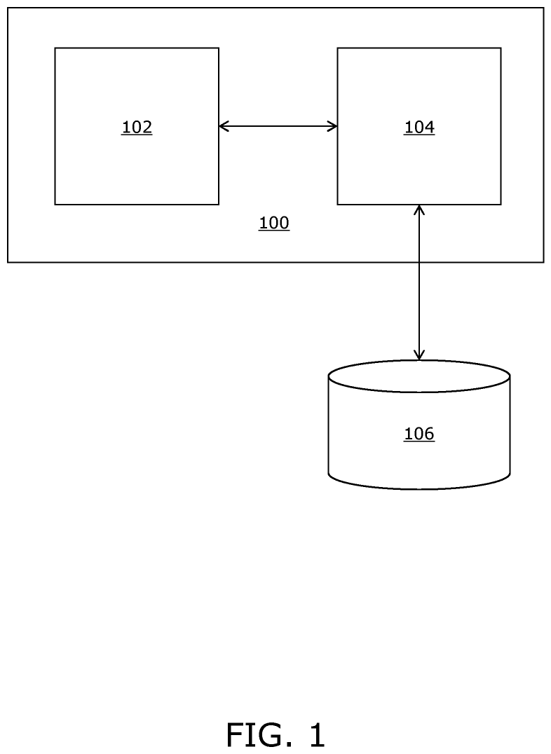

Referring to FIG. 1, illustrated is a block diagram of architecture of a system 100 for tracking a progress of a project, in accordance with an embodiment of the present disclosure. The system 100 comprises a memory 102 and one or more processors, depicted as a processor 104. The processor 104 is at least communicably coupled to a data repository 106, which stores data pertaining to at least one past project.

One or more programs are stored in the memory 102 and are configured for execution by the processor 104, wherein the one or more programs include instructions to:
receive, from the data repository 106, the data pertaining to the at least one past project;
classify the data pertaining to the at least one past project into a plurality of phases and their corresponding sub-phases;
for each sub-phase of each phase:
   determine a plurality of parameters of a software code associated with a given sub-phase;
   determine a total time spent in finishing the given sub-phase;
   find a correlation between the plurality of parameters determined for the given sub-phase and the total time spent in finishing the given sub-phase;
train a learning model, based on said correlation;
divide an ongoing project into a plurality of ongoing phases and their corresponding ongoing sub-phases and a plurality of next phases and their corresponding next sub-phases;
employ the learning model to determine a time that is estimated to be required to finish each of the plurality of ongoing phases and their corresponding ongoing sub-phases; and
compare the time that is estimated to be required with an actual time spent on each of the plurality of ongoing phases and their corresponding ongoing sub-phases, to track a progress of the ongoing project.

It may be understood by a person skilled in the art that FIG. 1 includes a simplified architecture of the system 100, for the sake of clarity, which should not unduly limit the scope of the claims herein. The person skilled in the art will recognize many variations, alternatives, and modifications of embodiments of the present disclosure. For example, the system may comprise the data repository 106.

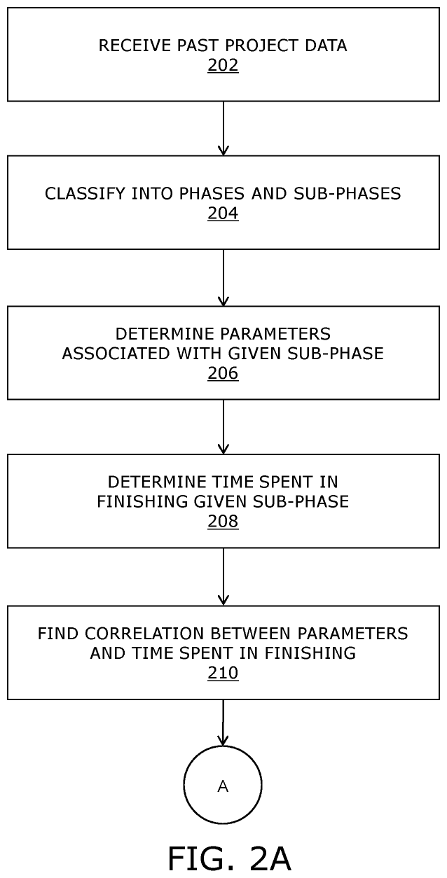

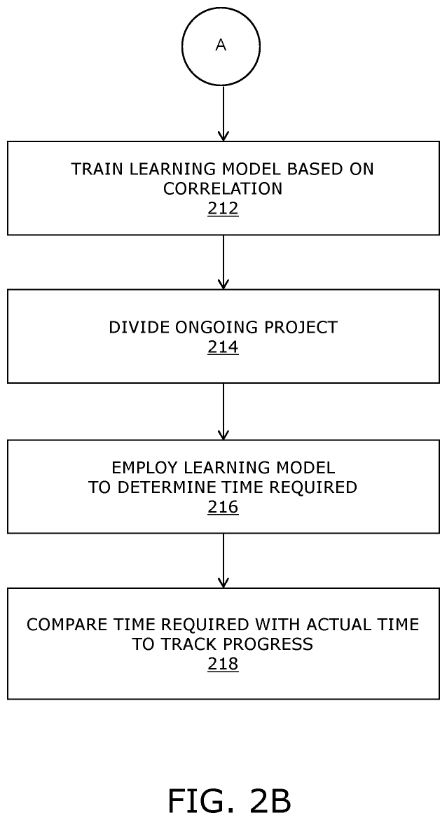

Referring to FIGS. 2A-2B, illustrated are steps of a method for tracking a progress of a project, in accordance with an embodiment of the present disclosure. At a step 202, data pertaining to at least one past project is received from a data repository. At a step 204, the data pertaining to the at least one past project is classified into a plurality of phases and their corresponding sub-phases. For each sub-phase of each phase, steps 206, 208 and 210 are performed. At the step 206, a plurality of parameters of a software code associated with a given sub-phase are determined. At the step 208, a total time spent in finishing the given sub-phase is determined. At the step 210, a correlation between the plurality of parameters determined for the given sub-phase and the total time spent in finishing the given sub-phase is found. At a step 212, a learning model is trained, based on said correlation.

At a step 214, an ongoing project is divided into a plurality of ongoing phases and their corresponding ongoing sub-phases and a plurality of next phases and their corresponding next sub-phases. At a step 216, the learning model is employed to determine a time that is estimated to be required to finish each of the plurality of ongoing phases and their corresponding ongoing sub-phases. Finally, at a step 218, the time that is estimated to be required is compared with an actual time spent on each of the plurality of ongoing phases and their corresponding ongoing sub-phases, to track a progress of the ongoing project.

The aforementioned steps are only illustrative and other alternatives can also be provided where one or more steps are added, one or more steps are removed, or one or more steps are provided in a different sequence without departing from the scope of the claims herein.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A computer-implemented method comprising:
receiving, from a data repository, data pertaining to at least one past project;
classifying the data pertaining to the at least one past project into a plurality of phases and their corresponding sub-phases;
for each sub-phase of each phase:
determining a plurality of parameters of a software code associated with a given sub-phase;
determining a total time spent in finishing the given sub-phase;
finding a correlation between the plurality of parameters determined for the given sub-phase and the total time spent in finishing the given sub-phase;
training a learning model, based on said correlation;
dividing an ongoing project into a plurality of ongoing phases and their corresponding ongoing sub-phases and a plurality of next phases and their corresponding next sub-phases;
employing the learning model to determine a time that is estimated to be required to finish each of the plurality of ongoing phases and their corresponding ongoing sub-phases; and
comparing the time that is estimated to be required with an actual time spent on each of the plurality of ongoing phases and their corresponding ongoing sub-phases, to track a progress of the ongoing project.

2. The computer-implemented method of claim 1, wherein the step of finding the correlation comprises finding a correlation between a given parameter and a time spent in fixing at least one bug arising in the software code due to the given parameter.

3. The computer-implemented method of claim 1, further comprising:
receiving a user feedback on a status of each sub-phase;
assigning a weight to a cumulation of preceding sub-phases of the given sub-phase, based on the user feedback; and
employing the assigned weight when determining the total time spent in finishing the given sub-phase.

4. The computer-implemented method of claim 1, wherein the plurality of parameters comprise at least one of: lines of code in the given sub-phase, a programming language used, time lapsed between release of a preceding sub-phase and the given sub-phase, cyclomatic complexity of the software code in the given sub-phase, defects resolved during the given sub-phase, a number of commits performed during the given sub-phase, files modified during each commit.

5. The compute-implemented method of claim 1, further comprising employing the learning model to estimate a time required to finish one or more of the plurality of next phases and their corresponding next sub-phases.

6. The computer-implemented method of claim 1, wherein the step of tracking the progress of the ongoing project comprises determining whether or not an actual time spent on a given ongoing phase or sub-phase exceeds the time that is estimated to be required to finish the given ongoing phase or sub-phase,
wherein the method further comprises sending an alert message to a user when the actual time spent on the given ongoing phase or sub-phase exceeds the time that is estimated to be required to finish the given ongoing phase or sub-phase.

7. The computer-implemented method of claim 6, wherein the alert message comprises a recommendation suggesting a corrective action to be taken.

8. A system comprising:
memory;
one or more processors; and
one or more programs stored in the memory and configured for execution by the one or more processors, the one or more programs including instructions to:
receive, from a data repository, data pertaining to at least one past project;
classify the data pertaining to the at least one past project into a plurality of phases and their corresponding sub-phases;
for each sub-phase of each phase:
determine a plurality of parameters of a software code associated with a given sub-phase;
determine a total time spent in finishing the given sub-phase;
find a correlation between the plurality of parameters determined for the given sub-phase and the total time spent in finishing the given sub-phase;
train a learning model, based on said correlation;
divide an ongoing project into a plurality of ongoing phases and their corresponding ongoing sub-phases and a plurality of next phases and their corresponding next sub-phases;
employ the learning model to determine a time that is estimated to be required to finish each of the plurality of ongoing phases and their corresponding ongoing sub-phases; and
compare the time that is estimated to be required with an actual time spent on each of the plurality of ongoing phases and their corresponding ongoing sub-phases, to track a progress of the ongoing project.

9. The system of claim 8, wherein the instructions to find the correlation comprises instructions to find a correlation between a given parameter and a time spent in fixing at least one bug arising in the software code due to the given parameter.

10. The system of claim 8, wherein the one or more programs further include instructions to:
receive a user feedback on a status of each sub-phase;
assign a weight to a cumulation of preceding sub-phases of the given sub-phase, based on the user feedback; and
employ the assigned weight when determining the total time spent in finishing the given sub-phase.

11. The system claim 8, wherein the plurality of parameters comprise at least one of: lines of code in the given sub-phase, a programming language used, time lapsed between release of a preceding sub-phase and the given sub-phase, cyclomatic complexity of the software code in the given sub-phase, defects resolved during the given sub-phase, a number of commits performed during the given sub-phase, files modified during each commit.

12. The system of claim 8, wherein the one or more programs further include instructions to employ the learning model to estimate a time required to finish one or more of the plurality of next phases and their corresponding next sub-phases.

13. The system of claim 8, wherein the instructions to track the progress of the ongoing project comprises instructions to determine whether or not an actual time spent on a given ongoing phase or sub-phase exceeds the time that is estimated to be required to finish the given ongoing phase or sub-phase,
wherein the one or more programs further include instructions to send an alert message to a user when the actual time spent on the given ongoing phase or sub-phase exceeds the time that is estimated to be required to finish the given ongoing phase or sub-phase.

14. The system of claim 13, wherein the alert message comprises a recommendation suggesting a corrective action to be taken.
